(19) United States
(12) Patent Application Publication
(10) Pub. No.: US 2020/0148536 A1
(43) Pub. Date: May 14, 2020

(54) OZONE GENERATOR

(71) Applicants: Kabushiki Kaisha Toshiba, Minato-ku, Tokyo (JP); Toshiba Infrastructure Systems & Solutions Corporation, Kawasaki-shi, Kanagawa (JP)

(72) Inventors: Kanako MORITANI, Yokohama (JP); Takaaki MURATA, Kawasaki (JP); Yuji OKITA, Kawasaki (JP); Kie KUBO, Toshima (JP)

(73) Assignees: Kabushiki Kaisha Toshiba, Minato-ku, Tokyo (JP); Toshiba Infrastructure Systems & Solutions Corporation, Kawasaki-shi, Kanagawa (JP)

(21) Appl. No.: 16/610,237

(22) PCT Filed: Mar. 19, 2018
(86) PCT No.: PCT/JP2018/010837

§ 371 Date: Nov. 1, 2019

(30) Foreign Application Priority Data
May 8, 2017 (JP) 2017-092379

(51) Int. Cl. C01B 13/11

(52) U.S. Cl. CPC C01B 13/115; C01B 2201/14; C01B 2201/72; C01B 2201/32; C01B 2201/22

(57) ABSTRACT

An ozone generator includes a container, a first metal electrode, a dielectric electrode, a heat pipe, a heat sink, and a power supply unit. The first metal electrode is a cylindrical electrode the axial direction of which is a first direction, and disposed in the container. A cooling medium is supplied to an outer peripheral surface thereof. The dielectric electrode is a cylindrical electrode that is disposed to be opposed to an inner peripheral surface of the first metal electrode, and is coaxial with the first metal electrode. The heat pipe is disposed to be opposed to an inner peripheral surface of the dielectric electrode, and has electrical conductivity. The heat sink is disposed on the outside as an outer space of a space between the first metal electrode and the heat pipe, and connected to the heat pipe.

### FIELD

Embodiments of the present invention relate to an ozone generator.

### BACKGROUND

In a discharge type ozone generator, it is important to enhance efficiency in cooling a discharge space for improving efficiency in generating ozone, and prevent pyrolysis of generated ozone.

### CITATION LIST

### Patent Literature

Patent Literature 1: Japanese Patent Application Laid-open No. 2012-206898

### SUMMARY OF THE INVENTION

### Problem to be Solved by the Invention

In the discharge type ozone generator described above, the discharge space is cooled from a grounding electrode side, but there is a demand for cooling the discharge space also from a high-voltage electrode side to prevent pyrolysis of the generated ozone, and further improving efficiency in generating ozone.

### Means for Solving Problem

An ozone generator according to an embodiment includes a container, a first metal electrode, a dielectric electrode, a heat pipe, a heat sink, and a power supply unit. A material gas is caused to flow into the container. The first metal electrode is a cylindrical electrode the axial direction of which is a first direction, and disposed in the container. A cooling medium is supplied to an outer peripheral surface thereof. The dielectric electrode is a cylindrical electrode that is disposed to be opposed to an inner peripheral surface of the first metal electrode, and is coaxial with the first metal electrode. The heat pipe is disposed to be opposed to an inner peripheral surface of the dielectric electrode, and has electrical conductivity. The heat sink is disposed on the outside as an outer space of a space between the first metal electrode and the heat pipe, and connected to the heat pipe. The power supply unit applies voltage to the heat pipe to cause electric discharge in the material gas in at least one of a first gap and a second gap to generate ozone by the electric discharge, the first gap being a gap into which the material gas is caused to flow between the first metal electrode and the dielectric electrode, the second gap being a gap into which the material gas is caused to flow between the dielectric electrode and the heat pipe.

### BRIEF DESCRIPTION OF DRAWINGS

FIG. 1 is a diagram illustrating an example of a schematic configuration of an ozone generator according to a first embodiment.

FIG. 2 is a diagram for explaining an example of processing of generating ozone performed by the ozone generator according to the first embodiment.

FIG. 3A is a diagram for explaining an example of processing of generating ozone performed by an ozone generator according to a second embodiment.

FIG. 3B is a diagram illustrating an example of a temperature change of gas in a first discharge gap and a second discharge gap of the ozone generator according to the second embodiment.

FIG. 4 is a diagram for explaining an example of processing of generating ozone performed by an ozone generator according to a third embodiment.

FIG. 5 is a diagram illustrating an example of a temperature change of gas in a first discharge gap and a second discharge gap of the ozone generator according to the third embodiment.

FIG. 6 is a diagram for explaining an example of processing of generating ozone performed by an ozone generator according to a fourth embodiment.

FIG. 7 is a diagram for explaining an example of processing of generating ozone performed by an ozone generator according to a fifth embodiment.

FIG. 8 is a diagram for explaining an example of a configuration of a space on a gas inlet side of an ozone generator according to a first modification.

FIG. 9 is a diagram for explaining an example of a configuration of a space on a gas inlet side of an ozone generator according to a second modification.

FIG. 10 is a diagram for explaining an example of a configuration of a space on a gas inlet side of an ozone generator according to a third modification.

FIG. 11 is a diagram for explaining an example of a configuration of a space on a gas inlet side of an ozone generator according to a fourth modification.

FIG. 12 is a diagram for explaining an example of a configuration of a space on a gas inlet side of an ozone generator according to a fifth modification.

FIG. 13 is a diagram for explaining an example of the configuration of the space on the gas inlet side of the ozone generator according to the fifth modification.

FIG. 14 is a diagram for explaining an example of a configuration of a space on a gas inlet side of an ozone generator according to a sixth modification.

FIG. 15 is a diagram illustrating an example of a heat sink included in an ozone generator according to a seventh modification.

FIG. 16 is a diagram for explaining an example of a configuration of a space on a gas inlet side of an ozone generator according to an eighth modification.

FIG. 17 is a diagram for explaining an example of a configuration of a space on a gas inlet side of an ozone generator according to a ninth modification.

FIG. 18 is a diagram illustrating an example of a configuration of a heat sink of an ozone generator according to a tenth modification.

FIG. 19 is a diagram illustrating an example of a configuration of a heat sink of an ozone generator according to an eleventh modification.

FIG. 20 is a diagram for explaining an example of processing of generating ozone performed by an ozone generator according to a twelfth modification.

### DETAILED DESCRIPTION

The following describes an ozone generator according to embodiments with reference to the attached drawings.

### First Embodiment

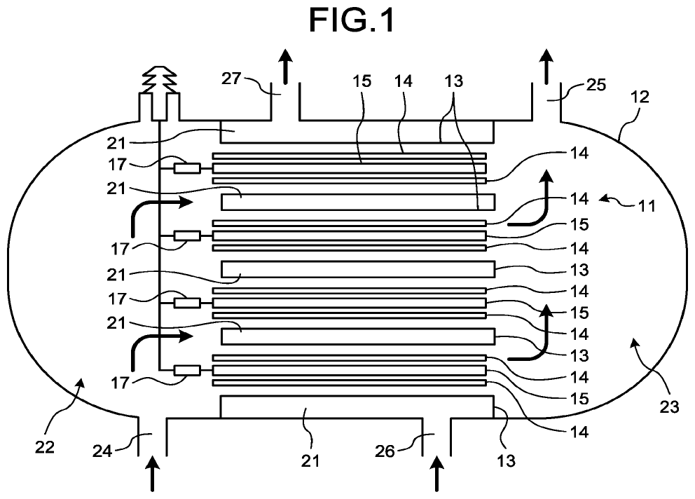

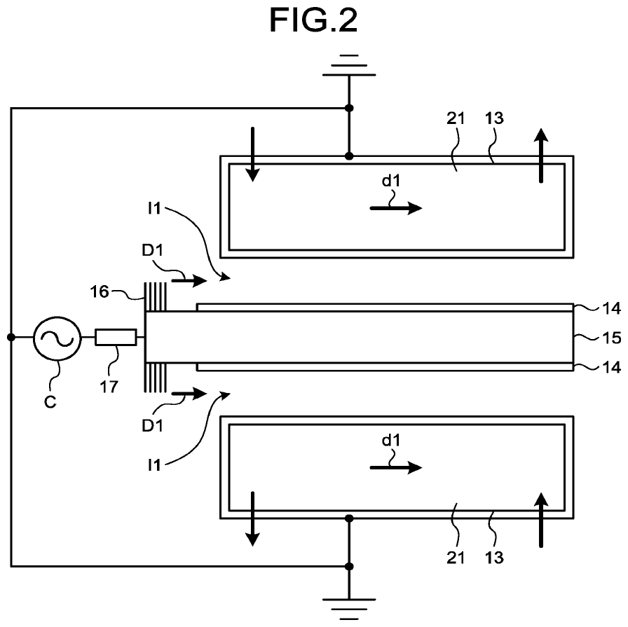

FIG. 1 is a diagram illustrating an example of a schematic configuration of an ozone generator according to a first embodiment. FIG. 2 is a diagram for explaining an example of processing of generating ozone performed by the ozone generator according to the first embodiment. The ozone generator according to the present embodiment is an ozone generator of dielectric barrier discharge type. As illustrated in FIG. 1, the ozone generator includes an ozone generator main body 11 and a storage container 12 (an example of a container) that houses the ozone generator main body 11 in an airtight state and receives a material gas that flows therein. In the present embodiment, the storage container 12 is a cylindrical container the axial direction of which is a first direction d1. The storage container 12 includes a plurality of metal electrodes 13, dielectric electrodes 14, heat pipes 15, and heat sinks 16 disposed therein.

The metal electrode 13 (an example of a first metal electrode) is a cylindrical electrode the axial direction of which is the first direction d1 as illustrated in FIG. 1 and FIG. 2. Cooling water (an example of a cooling medium) is supplied to an outer peripheral surface of the metal electrode 13. In the present embodiment, the metal electrode 13 is water-cooled by cooling water supplied to the outer peripheral surface thereof, but the embodiment is not limited thereto. The metal electrode 13 may be air-cooled by a cooling gas (an example of the cooling medium) supplied to the outer peripheral surface thereof. In the present embodiment, the metal electrode 13 is used as a grounding electrode.

As illustrated in FIG. 1 and FIG. 2, the dielectric electrode 14 is a cylindrical electrode that is disposed to be opposed to an inner peripheral surface of the metal electrode 13 and coaxial with the metal electrode 13. Between the dielectric electrode 14 and the metal electrode 13, there is disposed a gap I1 (hereinafter, referred to as a first discharge gap I1, an example of a first gap) into which a material gas such as oxygen or dry air is caused to flow.

As illustrated in FIG. 1 and FIG. 2, the heat pipe 15 is a heat pipe that is disposed to be opposed to an inner peripheral surface of the dielectric electrode 14 and has electrical conductivity. In the present embodiment, as illustrated in FIG. 2, the heat pipe 15 is in intimate contact with the inner peripheral surface of the dielectric electrode 14. That is, the heat pipe 15 is in contact with the inner peripheral surface of the dielectric electrode 14. In the present embodiment, the heat pipe 15 is made of metal or an alloy containing at least one of iron, aluminum, nickel, copper, molybdenum, titanium, chromium, tungsten, silver, gold, and platinum. Alternatively, the heat pipe is coated by the metal or alloy described above. Due to this, ozone resistance of the heat pipe 15 can be enhanced. In the present embodiment, the heat pipe 15 is used as a high-voltage electrode.

The heat sink 16 is disposed on the outside of the dielectric electrode 14. Specifically, the heat sink 16 is disposed on the outside, that is, an outer space of a space between the metal electrode 13 and the heat pipe 15. In other words, the heat sink 16 is disposed on the outside of the first discharge gap I1 and a second discharge gap I2 (described later). The heat sink 16 is connected to the heat pipe 15. Due to this, the gas in the first discharge gap I1 can be cooled by both of the heat pipe 15 and the cooling water supplied to the outer peripheral surface of the metal electrode 13, so that pyrolysis of ozone due to heat generated in the first discharge gap I1 can be prevented, and efficiency in generating ozone can be enhanced. In the present embodiment, the heat sink 16 is a fin disposed on an outer peripheral surface of the heat pipe 15 in a pinholder shape, a bellows shape, a plate shape, and the like. When the heat sink 16 is cooled by air cooling, oil cooling, and the like, the heat generated by the gas in the first discharge gap I1 is radiated by the heat sink 16 via the heat pipe 15.

The ozone generator main body 11 has a function of interrupting a current flow into the heat pipe 15, and interrupting a current flow into the dielectric electrode 14 at the time when the dielectric electrode 14 is in an anomaly state and the like (for example, a fuse 17). The fuse 17 is disposed between the heat pipe 15 and a power supply C. The power supply C (an example of a power supply unit) applies voltage to the heat pipe 15 to discharge electricity in the material gas in the first discharge gap I1 (hereinafter, referred to as dielectric barrier discharge), and generates ozone by the dielectric barrier discharge.

In the present embodiment, the storage container 12 includes a space 22 on a gas inlet side and a space 23 on a gas outlet side. The space 22 on the gas inlet side and the space 23 on the gas outlet side are connected to each other (communicate with each other) via the first discharge gap I1. The storage container 12 also includes a gas inflow port 24 for causing the material gas to flow into the storage container 12. The storage container 22 includes an ozone gas ejection port 25 for ejecting the gas (hereinafter, referred to as an ozone gas) that has flowed into the space 23 on the gas outlet side to the outside. The storage container 12 also includes a cooling water inflow port 26 for causing cooling water to flow into a closed space 21 of the metal electrode 13, and a cooling water ejection port 27 for ejecting, to the outside, high-temperature cooling water that has heat-exchanged with the metal electrode 13. The closed space 21 is a space disposed on the outer peripheral surface side of the metal electrode 13, and filled with the cooling water.

Next, the following describes a procedure of processing of generating ozone performed by the ozone generator according to the present embodiment. First, the material gas that has flowed into the space 22 on the gas inlet side flows into the first discharge gap Subsequently, voltage (for example, AC voltage) is applied to the heat pipe 15 from the power supply C, and dielectric barrier discharge is caused in the material gas that has flowed into the first discharge gap I1. Due to this, an oxygen molecule contained in the material gas that has flowed into the first discharge gap I1 is dissociated into an oxygen atom, another oxygen atom is connected thereto to ozonize the material gas, and the ozone gas is generated. Thereafter, the generated ozone gas flows out to the space 23 on the gas outlet side, and is ejected to the outside through the ozone gas ejection port 25.

To remove the heat that is generated in the discharge gap I1 due to the dielectric barrier discharge, cooling water is caused to flow into the closed space 21 from the outside via the cooling water inflow port 26. Due to this, heat is exchanged between the metal electrode 13 and the cooling water, and the inside of the discharge gap is cooled. Thereafter, the cooling water the temperature of which is raised due to heat exchange is ejected to the outside via the cooling water ejection port 27.

Additionally, in a case in which an anomaly appears in the heat pipe 15 due to a dielectric breakdown and the like, the fuse 17 disposed between the heat pipe 15 and the power supply C is blown out by a short-circuit current flowing in the heat pipe 15 in which the anomaly appears, and the heat pipe 15 is disconnected from the other heat pipe 15. Accordingly, an electric charge charged in the first discharge gap I1 between the normal heat pipe 15 and the metal electrode 13 can be prevented from flowing into the heat pipe 15 in which an anomaly appears, so that, even when an anomaly appears in some of the heat pipes 15, ozone can be continuously generated by causing dielectric barrier discharge between the normal heat pipe 15 and the metal electrode 13. In the present embodiment, the ozone generator main body 11 includes the fuse 17, but does not necessarily include the fuse 17 in a case of having a function similar to that of the fuse 17 or a case in which there is no need.

As described above, the ozone generator having the configuration described above uses the heat pipe 15 as a high-voltage electrode, applies voltage to the heat pipe 15, and causes dielectric barrier discharge in the material gas in the first discharge gap I1 between the metal electrode 13 and the dielectric electrode 14 to generate ozone by the dielectric barrier discharge. At this point, the heat pipe 15 enhances movement efficiency of the heat generated in the gas in the first discharge gap I1, and the gas in the first discharge gap I1 is cooled (air-cooled) also with the heat pipe 15.

Accordingly, the material gas in the first discharge gap I1 is cooled by both of the heat pipe 15 and the cooling water supplied to the outer peripheral surface of the metal electrode 13, and a temperature rise of the gas in the first discharge gap I1 can be suppressed, so that efficiency in generating ozone in the first discharge gap I1 can be enhanced. The cooling water is not used for cooling the gas in the first discharge gap I1 by the heat pipe 15. Thus, it is not required to newly dispose members such as a gasket, a tube, and piping for causing the cooling water to flow into the inner part of the high-voltage electrode of the ozone generator in the related art, so that the structure of the ozone generator can be prevented from being complicated. Additionally, the number of points at which the cooling water for cooling the gas in the first discharge gap I1 is caused to flow is reduced, so that a risk of leakage of the cooling water in the ozone generator can be reduced, and the weight of the ozone generator can be reduced.

In a case of disposing the heat sink 16 in the storage container 12 and cooling the heat sink 16 with the material gas, the heat sink 16 is preferably disposed at a position at which the temperature of the material gas is lower within the storage container 12. Thus, in the present embodiment, the heat sink 16 is disposed in the vicinity of a position at which the material gas is caused to flow into the storage container 12. For example, the heat sink 16 is disposed in the space 22 on the gas inlet side, and in the vicinity of the gas inflow port 24. Due to this, the heat sink 16 can be cooled with the material gas having a lower temperature, so that efficiency in cooling the gas in the first discharge gap I1 by the heat pipe 15 can be further enhanced, and efficiency in generating ozone in the first discharge gap I1 can be enhanced. The heat sink 16 is disposed in the vicinity of the gas inflow port 24 in the present embodiment, but it is sufficient that the heat sink 16 is disposed on an upstream side of the first discharge gap I1 in an inflow direction Dl of the material gas.

To further enhance efficiency in cooling the gas in the first discharge gap I1 with the heat pipe 15 and the heat sink 16, the ozone generator may be configured such that a stirring unit such as a fan is disposed in the space 22 on the gas inlet side (for example, in the vicinity of the gas inflow port 24) to stir the material gas in the storage container 12 to enable heat to be easily radiated from the heat sink 16. Due to this, the heat sink 16 can be cooled with the material gas having a lower temperature, so that efficiency in cooling the gas in the first discharge gap I1 by the heat pipe 15 can be further enhanced, and efficiency in generating ozone in the first discharge gap I1 can be enhanced.

In this way, with the ozone generator according to the first embodiment, the material gas in the first discharge gap I1 is cooled by both of the heat pipe 15 and the cooling water supplied to the metal electrode 13, and a temperature rise of the gas in the first discharge gap I1 can be suppressed, so that efficiency in generating ozone in the first discharge gap I1 can be enhanced.

### Second Embodiment

The present embodiment is an example of causing dielectric barrier discharge in the material gas in the second discharge gap into which the material gas is caused to flow between the dielectric electrode and the heat pipe. In the following description, description about the same points as the first embodiment will not be repeated.

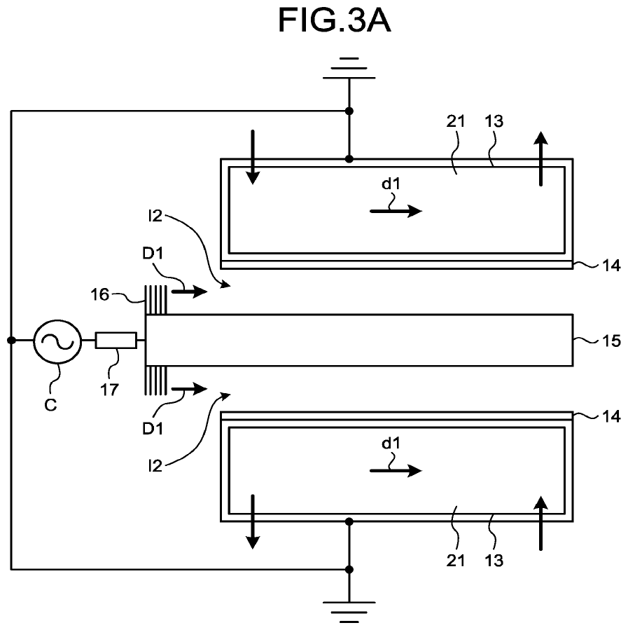

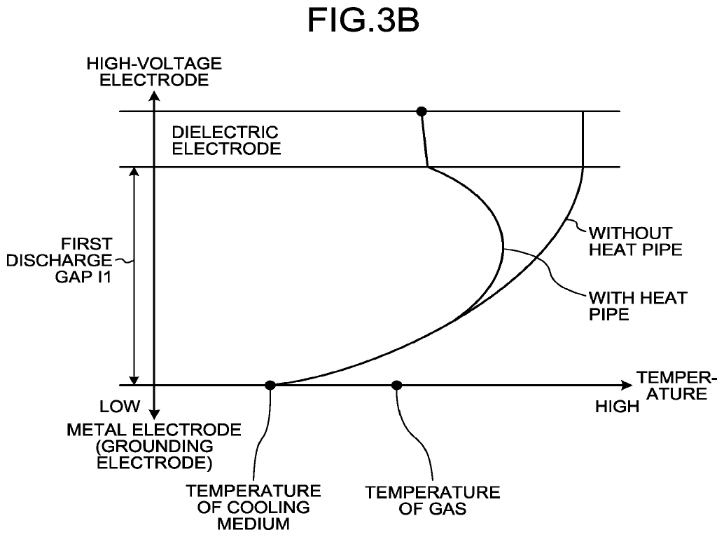

FIG. 3A is a diagram for explaining an example of processing of generating ozone performed by the ozone generator according to a second embodiment. As illustrated in FIG. 3A, in the present embodiment, the dielectric electrode 14 is in intimate contact with the inner peripheral surface of the metal electrode 13. In other words, the dielectric electrode 14 is in contact with the inner peripheral surface of the metal electrode 13. In the present embodiment, the heat pipe 15 is disposed to be opposed to the inner peripheral surface of the dielectric electrode 14 and to be separated from the inner peripheral surface. That is, a gap I2 (hereinafter, referred to as a second discharge gap I2, an example of a second gap) into which the material gas is caused to flow is disposed between the heat pipe 15 and the dielectric electrode 14.

Similarly to the first embodiment, the ozone generator uses the heat pipe 15 as a high-voltage electrode, applies voltage to the heat pipe 15 to cause dielectric barrier discharge in the material gas in the second discharge gap I2 between the dielectric electrode 14 and the heat pipe 15, and generates ozone by the dielectric barrier discharge. In this case, the heat pipe 15 enhances movement efficiency of heat generated by the gas in the second discharge gap I2, and the gas in the second discharge gap I2 is cooled (air-cooled) also with the heat pipe 15.

FIG. 3B is a diagram illustrating an example of a temperature change of the gas in the first discharge gap and the second discharge gap of the ozone generator according to the second embodiment. In FIG. 3B, a vertical axis represents a position between the heat pipe 15 and the metal electrode 13, and a horizontal axis represents a temperature of the gas between the heat pipe 15 and the metal electrode 13. As illustrated in FIG. 3B, in a case of not using the heat pipe 15 as the high-voltage electrode, the temperature of the gas in the first discharge gap I1 rises as being closer to the high-voltage electrode. In contrast, in a case of using the heat pipe 15 as the high-voltage electrode, the gas in the first discharge gap I1 can be cooled also with the heat pipe 15, so that the temperature of the gas in the first discharge gap I1 is reduced. Thus, according to the present embodiment, a temperature rise of the gas in the first discharge gap I1 can be suppressed, so that efficiency in generating ozone in the first discharge gap I1 can be enhanced.

Accordingly, with the ozone generator according to the second embodiment, a working effect similar to that of the first embodiment can be obtained.

In the present embodiment, to enhance efficiency in cooling the gas in the second discharge gap I2, a spiral-shaped groove is disposed on the outer peripheral surface of the heat pipe 15 in the first direction d1 to generate a swirl flow of the material gas in the second discharge gap I2. Due to this, the gas in the second discharge gap I2 is caused to flow from the space 22 on the gas inlet side toward the space 23 on the gas outlet side while being stirred, so that the gas in the second discharge gap I2 can be cooled more uniformly.

### Third Embodiment

The present embodiment is an example of causing dielectric barrier discharge in the material gas in both of the first discharge gap into which the material gas is caused to flow between the metal electrode and the dielectric electrode and the second discharge gap into which the material gas is caused to flow between the dielectric electrode and the heat pipe. In the following description, description about the same points as the embodiments described above will not be repeated.

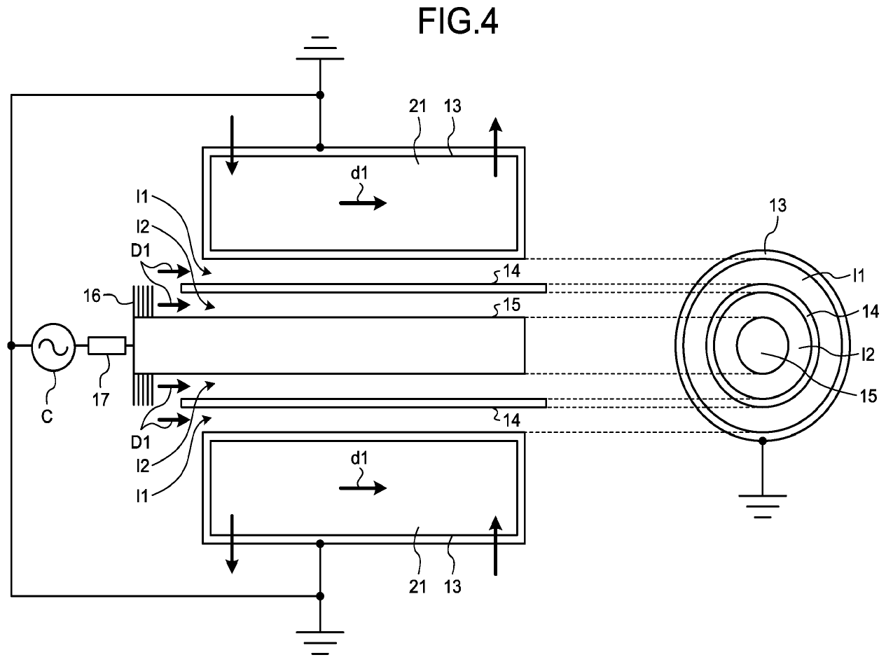

FIG. 4 is a diagram for explaining an example of processing of generating ozone performed by the ozone generator according to a third embodiment. As illustrated in FIG. 4, in the present embodiment, the dielectric electrode 14 is disposed to be opposed to the inner peripheral surface of the metal electrode 13 and to be separated from the inner peripheral surface. That is, the first discharge gap I1 into which the material gas is caused to flow is disposed between the dielectric electrode 14 and the metal electrode 13. Additionally, in the present embodiment, the heat pipe 15 is disposed to be opposed to the inner peripheral surface of the dielectric electrode 14 and to be separated from the inner peripheral surface. That is, the second discharge gap I2 into which the material gas is caused to flow is disposed between the heat pipe 15 and the dielectric electrode 14.

Similarly to the first and the second embodiments, the ozone generator uses the heat pipe 15 as the high-voltage electrode, applies voltage to the heat pipe 15 to cause dielectric barrier discharge in the material gas in the first discharge gap I1 between the metal electrode 13 and the dielectric electrode 14 and in the second discharge gap I2 between the dielectric electrode 14 and the heat pipe 15, and generates ozone by the dielectric barrier discharge. In this case, the heat pipe 15 enhances movement efficiency of heat generated by the gas in the second discharge gap I2, and the gas in the second discharge gap I2 is cooled (air-cooled) also with the heat pipe 15.

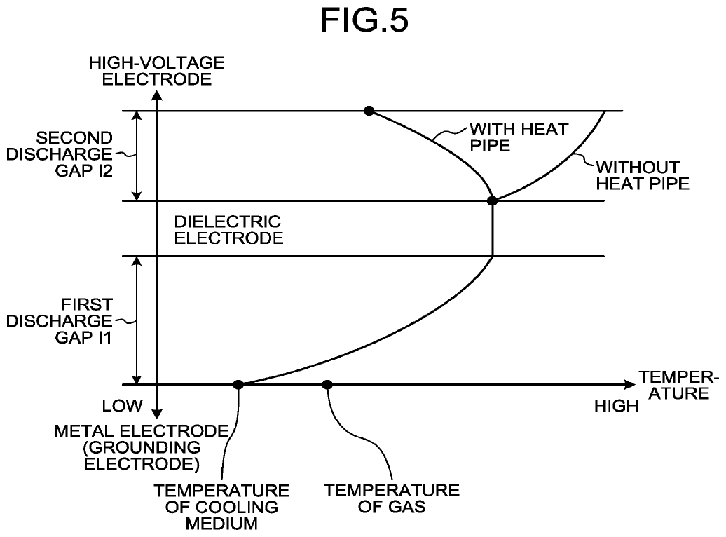

FIG. 5 is a diagram illustrating an example of a temperature change of the gas in the first discharge gap and the second discharge gap of the ozone generator according to the third embodiment. In FIG. 5, a vertical axis represents a position between the heat pipe 15 and the metal electrode 13, and a horizontal axis represents the temperature of the gas between the heat pipe 15 and the metal electrode 13. As illustrated in FIG. 5, in a case of not using the heat pipe 15 as the high-voltage electrode, the temperature of the gas in the second discharge gap I2 rises as being closer to the high-voltage electrode. In contrast, in a case of using the heat pipe 15 as the high-voltage electrode, the gas in the discharge gap can be cooled also with the heat pipe 15, so that the temperature of the gas in the second discharge gap I2 is reduced. Thus, according to the present embodiment, a temperature rise of the gas in the second discharge gap I2 can be suppressed, so that efficiency in generating ozone in the second discharge gap I2 can be enhanced.

Accordingly, with the ozone generator according to the third embodiment, a working effect similar to that of the first embodiment can be obtained.

Also in the present embodiment, to enhance efficiency in cooling the gas in the second discharge gap 12, a spiral-shaped groove is disposed on the outer peripheral surface of the heat pipe 15 in the first direction d1 to generate a swirl flow of the gas in the second discharge gap I2. Due to this, the gas in the second discharge gap I2 is caused to flow from the space 22 on the gas inlet side toward the space 23 on the gas outlet side while being stirred, so that the gas in the second discharge gap I2 can be cooled more uniformly.

### Fourth Embodiment

The present embodiment is an example of causing dielectric barrier discharge in the material gas in both of the first discharge gap and the second discharge gap, and including a flow channel for the material gas that passes through the first discharge gap after passing through the second discharge gap. In the following description, description about the same points as the third embodiment will not be repeated.

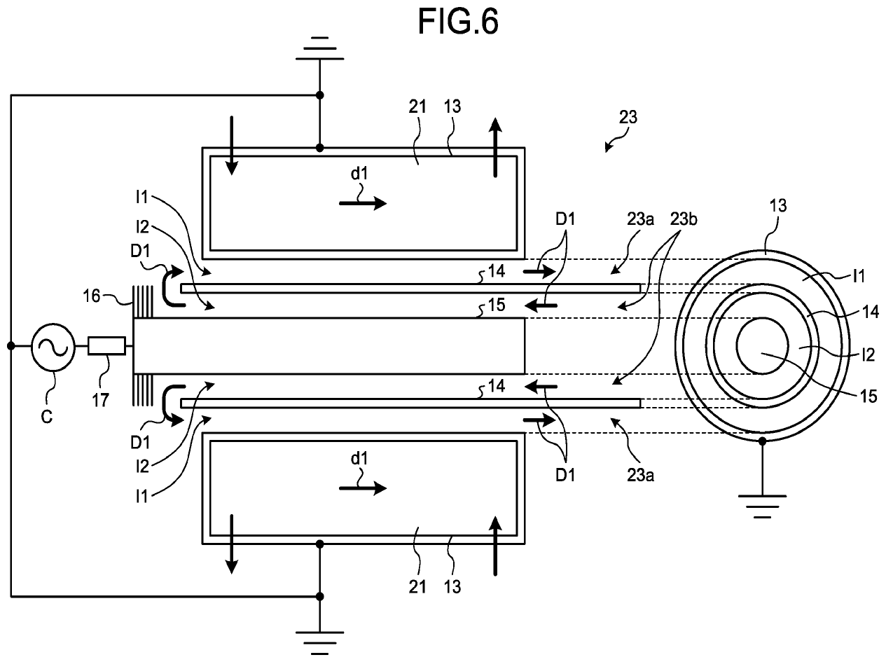

FIG. 6 is a diagram for explaining an example of processing of generating ozone performed by the ozone generator according to a fourth embodiment. As illustrated in FIG. 6, in the present embodiment, a dielectric 14 is disposed between a first space 23a on the gas outlet side continuous to the first discharge gap I1 and a second space 23b on the gas outlet side continuous to the second discharge gap I2 in the space 23 on the gas outlet side. Due to this, the first space 23a on the gas outlet side and the second space 23b on the gas outlet side are isolated (separated) from each other. In the present embodiment, the second space 23b on the gas outlet side includes the gas inflow port 24, and the first space 23a on the gas outlet side includes the ozone gas ejection port 25. With the configuration described above, as illustrated in FIG. 6, the ozone generator according to the present embodiment forms a flow channel (serial flow channel) for the material gas that passes through the first discharge gap I1 after passing through the second discharge gap I2.

In the ozone generator, a chiller is often used for circulating the cooling water to be supplied to the closed space 21. In such a case, the temperature of the cooling water in the closed space 21 becomes lower than the temperature of the material gas. Thus, the temperature of the gas in the second discharge gap I2 becomes higher than the temperature of the material gas in the first discharge gap I1. Due to this, in a case in which the ozone generator includes a flow channel (parallel flow channel) for the material gas that passes through only one of the first discharge gap I1 and the second discharge gap I2, efficiency in generating the ozone gas in the second discharge gap I2 is decreased. Thus, in the present embodiment, a serial flow channel is formed for the material gas that passes through the first discharge gap I1 after passing through the second discharge gap I2.

Accordingly, with the ozone generator according to the fourth embodiment, even when ozone cannot be sufficiently generated in the second discharge gap I2 in which the temperature of the material gas easily rises, ozone is generated again in the first discharge gap I1 having a high effect of cooling the material gas, so that efficiency in generating the ozone gas can be enhanced.

### Fifth Embodiment

The present embodiment is an example in which a plurality of heat pipes are arranged in parallel in the first direction to be opposed to the inner peripheral surface of one dielectric electrode. In the following description, description about the same points as the third embodiment will not be repeated.

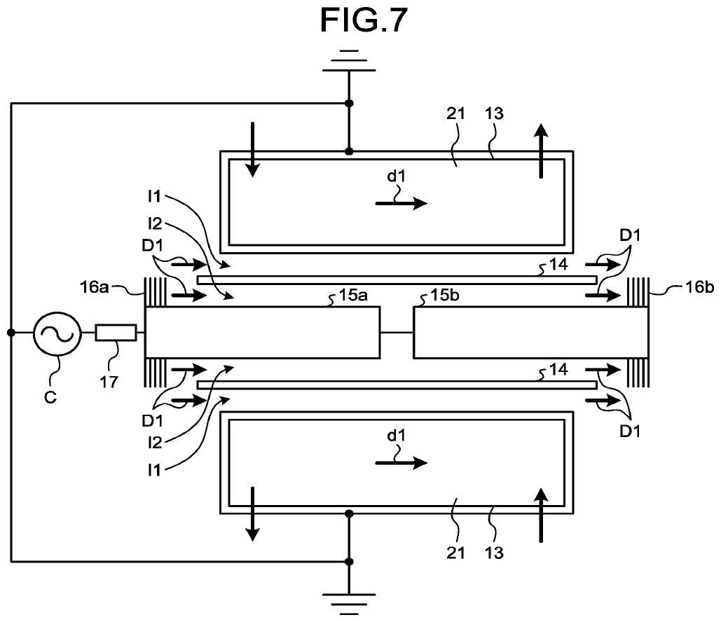

FIG. 7 is a diagram for explaining an example of processing of generating ozone performed by the ozone generator according to the fifth embodiment. As illustrated in FIG. 7, in the present embodiment, two heat pipes 15a and 15b are arranged in parallel in the first direction d1 to be opposed to the inner peripheral surfaces of the dielectric electrodes 14 that are disposed in the storage container 12. A heat sink 16a connected to the heat pipe 15a positioned on the upstream side in the inflow direction Dl of the material gas is positioned in the space 22 on the gas inlet side. On the other hand, a heat sink 16b connected to the heat pipe 15b positioned on the downstream side in the inflow direction Dl of the material gas is positioned in the space 23 on the gas outlet side. The example of arranging the heat pipes 15 in parallel in the first direction d1 to be opposed to the inner peripheral surface of one dielectric electrode 14 can also be applied to the ozone generator according to the first to the third embodiments.

Accordingly, with the ozone generator according to the fifth embodiment, a discharge area in a longitudinal direction of the heat pipe 15 disposed in the dielectric electrode 14 can be prolonged, so that a diameter of the storage container 12 can be reduced.

### First Modification

The present modification is an example in which the heat sink is disposed on the upstream side of the metal electrode in the inflow direction of the material gas, and a diameter of the gas inflow port is smaller than a diameter of the ozone gas ejection port. In the following description, description about the same configuration as that in the embodiments described above will not be repeated.

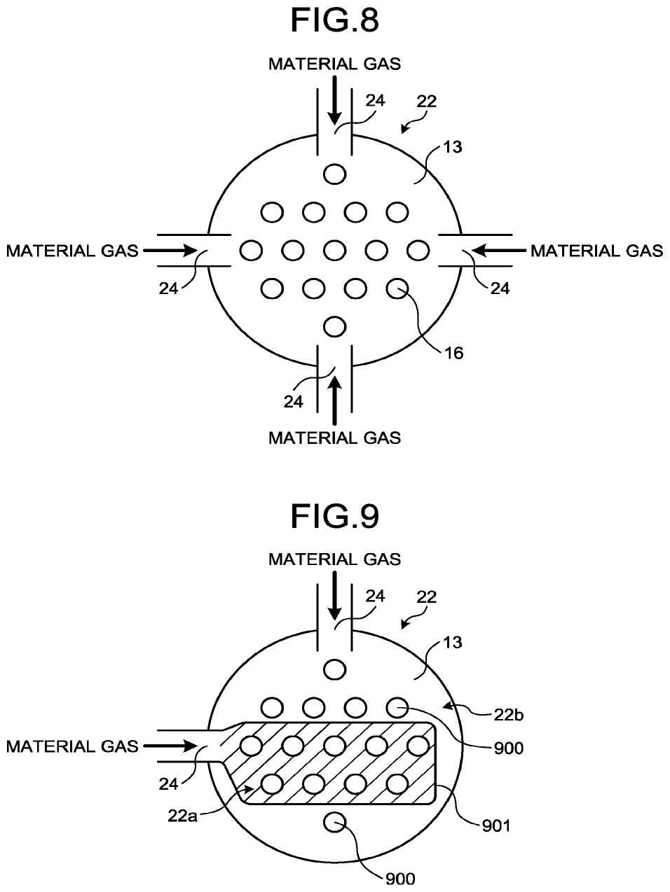

FIG. 8 is a diagram for explaining an example of a configuration of the space on the gas inlet side of the ozone generator according to a first modification. In the present modification, the heat sink 16 is disposed in the space 22 on the gas inlet side. In other words, the heat sink 16 is disposed on the upstream side of the first discharge gap I1 in the inflow direction Dl of the material gas.

As illustrated in FIG. 8, in the present modification, a plurality of the gas inflow ports 24 are disposed in the space 22 on the gas inlet side so that the material gas is introduced from the inner peripheral surface of the space 22 on the gas inlet side toward the center of the space 22 on the gas inlet side. The diameter of the gas inflow port 24 is smaller than the diameter of the ozone gas ejection port 25. Due to this, a flow speed of the material gas can be increased at the time of being caused to flow into the storage container 12, so that cooling efficiency of the heat sink 16 disposed in the space 22 on the gas inlet side can be enhanced.

### Second Modification

The present modification is an example in which a cylindrical metal electrode (hereinafter, referred to as a normal metal electrode) coaxial with the dielectric electrode is disposed, in place of the heat pipe, to be opposed to the inner peripheral surfaces of some of the dielectric electrodes in the storage container, and the flow speed of the material gas flowing into the first discharge gap and the second discharge gap is higher than the flow speed of the material gas flowing into a third discharge gap into which the material gas is caused to flow between the normal metal electrode and the dielectric electrode or the metal electrode. In the following description, description about the same configuration as that of the embodiments described above will not be repeated.

FIG. 9 is a diagram for explaining an example of a configuration of the space on the gas inlet side of the ozone generator according to a second modification. In the present modification, as illustrated in FIG. 9, a normal metal electrode 900 (an example of a second metal electrode) is disposed, in place of the heat pipe 15, to be opposed to the inner peripheral surfaces of some of the dielectric electrodes 14 disposed in the storage container 12. In the present modification, in the space 22 on the gas inlet side, an area 22a in which the heat sink 16 is disposed (hereinafter, referred to as a heat pipe electrode area) is isolated (separated) from an area 22b in which the normal metal electrode 900 is disposed (hereinafter, referred to as a metal electrode area). In the present modification, as illustrated in FIG. 9, the ozone generator includes a wall 901 for partitioning the heat pipe electrode area 22a and the metal electrode area 22b between the heat pipe electrode area 22a and the metal electrode area 22b. In the ozone generator, the diameter of the gas inflow port 24 for causing the material gas to flow into the heat pipe electrode area 22a is smaller than the diameter of the gas inflow port 24 for causing the material gas to flow into the metal electrode area 22b.

With the configuration described above, the flow speed of the material gas flowing into the first discharge gap I1 and the second discharge gap I2 becomes higher than the flow speed of the material gas flowing into the third discharge gap into which the material gas is caused to flow between the normal metal electrode 900 and the dielectric electrode 14 or the metal electrode 13. Due to this, the flow speed of the material gas flowing into the first discharge gap I1 and the second discharge gap I2 can be increased, so that cooling efficiency of the heat sink 16 can be enhanced.

### Third Modification

The present modification is an example in which the gas inflow port for the material gas that flows into the storage container is disposed so that the material gas swirls in a circumferential direction along the inner peripheral surface of the storage container. In the following description, description about the same points as the embodiments described above will not be repeated.

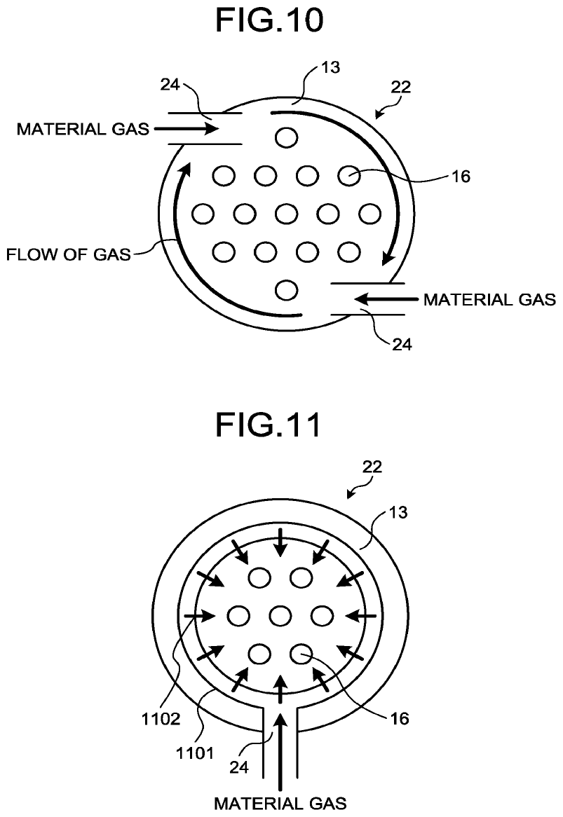

FIG. 10 is a diagram for explaining an example of a configuration of the space on the gas inlet side of the ozone generator according to a third modification. In the present modification, as illustrated in FIG. 10, the material gas is swirled along the inner peripheral surface of the storage container 12 by disposing the gas inflow port 24 to cause the material gas to flow in a tangential direction of the inner peripheral surface of the space 22 on the gas inlet side. Due to this, the material gas that is caused to flow into the storage container 12 is stirred, and the temperature of the entire material gas in the storage container 12 can be lowered, so that cooling efficiency of the heat sink 16 disposed in the space 22 on the gas inlet side can be enhanced.

### Fourth Modification

The present modification is an example of including a material gas pipe that is disposed to surround the heat sink, and has an ejection hole for ejecting the material gas toward the heat sink. In the following description, description about the same points as the first to the fourth embodiments will not be repeated.

FIG. 11 is a diagram for explaining an example of a configuration of the space on the gas inlet side of the ozone generator according to a fourth modification. In the present modification, as illustrated in FIG. 11, the ozone generator includes a doughnut-shaped material gas pipe 1101 that circularly surrounds the heat sink 16 positioned in the space 22 on the gas inlet side. The material gas pipe 1101 is connected to the gas inflow port 24, and the material gas is caused to flow into the pipe. The material gas pipe 1101 has an ejection hole 1102 for ejecting the material gas flowing therein toward a region that is circularly surrounded by the material gas pipe 1101 (that is, the heat sink 16). Due to this, the material gas can be caused to hit the side surface of the heat sink 16, so that cooling efficiency of the heat sink 16 can be enhanced.

### Fifth Modification

The present modification is an example in which a pipe for cooling is disposed between the heat sink and the material gas pipe to surround the heat sink, and a cooling medium is supplied into the pipe for cooling. In the following description, description about the same points as the fourth modification will not be repeated.

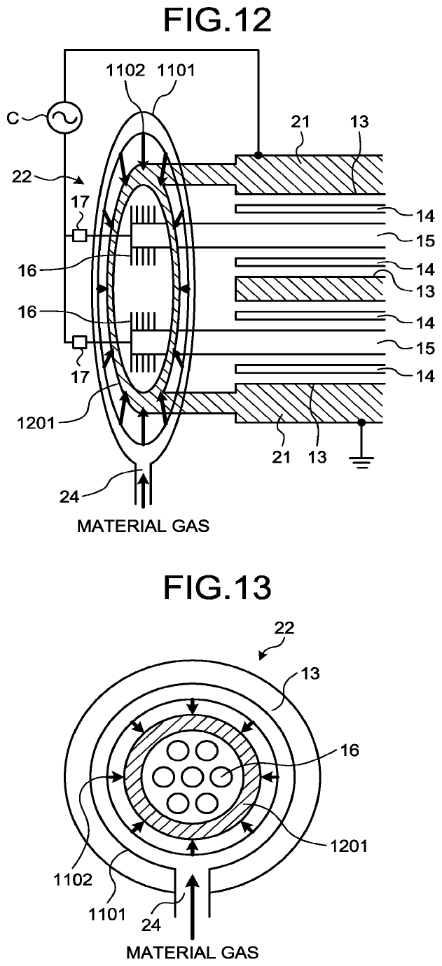

FIG. 12 and FIG. 13 are diagrams for explaining an example of a configuration of the space on the gas inlet side of the ozone generator according to a fifth modification. In the present modification, as illustrated in FIG. 12 and FIG. 13, the ozone generator includes a doughnut-shaped pipe for cooling 1201 that is disposed between the heat sink 16 and the material gas pipe 1101 to circularly surround the heat sink 16. The cooling medium is supplied into the pipe for cooling 1201. In the present embodiment, as illustrated in FIG. 12, the pipe for cooling 1201 is connected to the closed space 21, and the cooling medium supplied to the closed space 21 is supplied into the pipe for cooling 1201. Due to this, after causing the material gas ejected from the ejection hole 1102 for the material gas pipe 1101 to hit the pipe for cooling 1121 to be cooled, the material gas can be caused to hit the side surface of the heat sink 16, so that cooling efficiency of the heat sink 16 can be further enhanced.

### Sixth Modification

The present modification is an example of including a wall for partitioning between a discharge space in which the metal electrode, the dielectric electrode, and the heat pipe are disposed, and a non-discharge space in which the heat sink is disposed. In the following description, description about the same points as the embodiments described above will not be repeated.

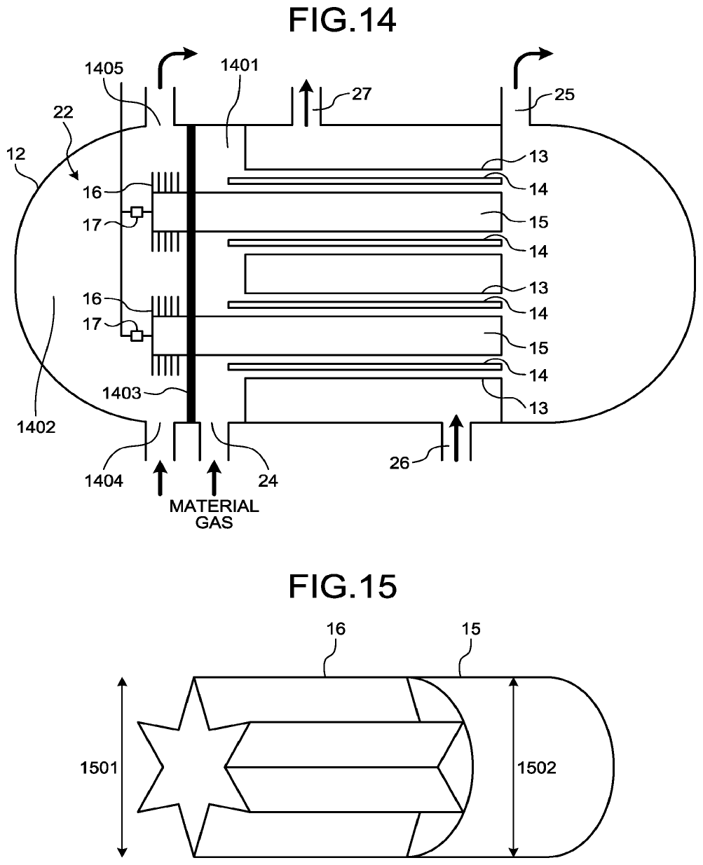

FIG. 14 is a diagram for explaining an example of a configuration of the space on the gas inlet side of the ozone generator according to a sixth modification. In the present modification, as illustrated in FIG. 14, the ozone generator includes, in the space 22 on the gas inlet side, a wall 1403 that partitions between a discharge space 1401 (an example of a first area) and a non-discharge space 1402 (an example of a second area). In discharge space 1401, the metal electrode 13, the dielectric electrode 14, and the heat pipe 15 are disposed. In the non-discharge space 1402, the heat sink 16 is disposed. Due to this, the heat sink 16 is disposed on the outside of the discharge space 1401. The wall 1403 is orthogonal to the first direction d1.

The gas inflow port 24 is disposed in the discharge space 1401, and the material gas is caused to flow thereinto through the gas inflow port 24. A cooling medium (for example, an insulating oil or air) for cooling the heat sink 16 is introduced into the non-discharge space 1402 through a cooling medium inflow port 1404 that is disposed on one end of an inner peripheral surface of the non-discharge space 1401, and the cooling medium is ejected through a cooling medium ejection port 1405 that is disposed on the other end of the inner peripheral surface of the non-discharge space 1402.

Due to this, it is possible to reduce a temperature rise in the heat sink 16 due to influence of a temperature rise of the material gas in at least one of the first discharge gap I1 and the second discharge gap I2, so that cooling efficiency of the heat sink 16 can be enhanced.

### Seventh Modification

The present modification is an example in which an outer diameter of the heat sink is equal to or smaller than an outer diameter of the heat pipe, and the heat sink has a polygonal cross section. In the following description, description about the same points as the embodiments described above will not be repeated.

FIG. 15 is a diagram illustrating an example of the heat sink included in the ozone generator according to a seventh modification. As illustrated in FIG. 15, in the present modification, an outer diameter 1501 of the heat sink 16 is caused to be identical to an outer diameter 1502 of the heat pipe 15. Additionally, as illustrated in FIG. 15, the cross section of the heat sink 16 is caused to have a polygonal shape such as a star shape to increase the surface area of the heat sink 16. Due to this, it is possible to shorten a distance between the heat sinks 16 that are disposed to be adjacent to each other in the storage container 12, so that the number of heat sinks 16 housed in the storage container 12 can be increased.

### Eighth Modification

The present modification is an example in which the wall disposed in the space on the gas inlet side has a connection hole that connects the discharge space with the non-discharge space at one end thereof, and has the gas inflow port at an end opposite to the end at which the connection hole is disposed in the non-discharge space. In the following description, description about the same points as the sixth modification will not be repeated.

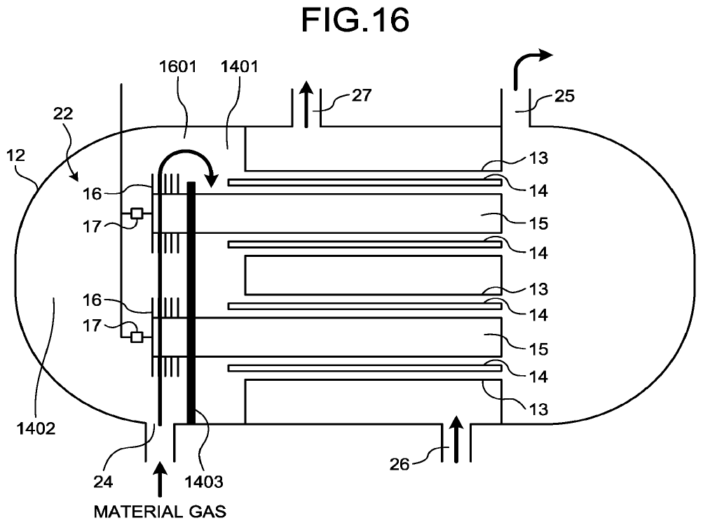

FIG. 16 is a diagram for explaining an example of a configuration of the space on the gas inlet side of the ozone generator according to an eighth modification. In the present modification, as illustrated in FIG. 16, the wall 1403 has a connection hole 1601 that connects the discharge space 1401 with the non-discharge space 1402 at one end thereof. In the space 22 on the gas inlet side, the gas inflow port 24 is disposed at an end opposite to the end at which the connection hole 1601 is disposed in the non-discharge space 1402.

Due to this, the heat sink 16 can be cooled without supplying a cooling medium other than the material gas to the non-discharge space 1402, and it is possible to suppress a temperature rise of the heat sink 16 due to influence of a temperature rise of the material gas in the first discharge gap I1 or the second discharge gap I2, so that cooling efficiency of the heat sink 16 can be enhanced with a simpler configuration.

### Ninth Modification

The present modification is an example in which the metal electrode includes a metal electrode not including the dielectric electrode and the heat pipe disposed on the inner peripheral surface side thereof (hereinafter, referred to as a non-discharge electrode), and the material gas is introduced into the non-discharge space through a pipe of the non-discharge electrode. In the following description, description about the same points as the eighth modification will not be repeated.

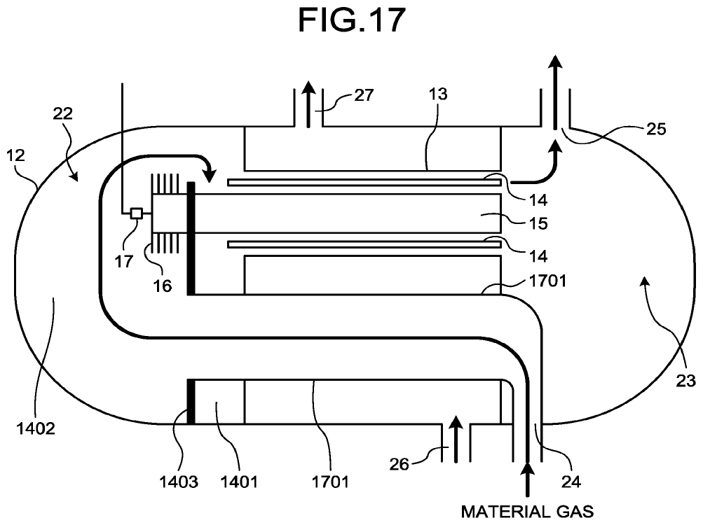

FIG. 17 is a diagram for explaining an example of a configuration of the space on the gas inlet side of the ozone generator according to a ninth modification. In the present modification, as illustrated in FIG. 17, the metal electrode 13 includes a non-discharge electrode 1701 (an example of a third metal electrode) as the metal electrode 13 connected to the non-discharge space 1402, the dielectric electrode 14 and the heat pipe 15 being not disposed to be opposed to the inner peripheral surface thereof. In the present modification, the non-discharge electrode 1701 is connected to the gas inflow port 24 disposed in the space 23 on the gas outlet side, and the material gas is caused to flow into the pipe thereof. The material gas passed through the pipe of the non-discharge electrode 1701 is caused to flow into the non-discharge space 1402. With the configuration described above, the ozone generator causes the material gas to flow into the non-discharge space 1402 through the pipe of the non-discharge electrode 1701. Due to this, the material gas cooled in the non-discharge electrode 1701 can be caused to flow into the non-discharge space 1402, so that cooling efficiency of the heat sink 16 can be enhanced under the condition that the temperature of the cooling water supplied to the outer peripheral surface of the non-discharge electrode 1701 is lower than the temperature of the material gas.

### Tenth Modification

The present modification is an example in which the heat pipes are connected to one heat sink. In the following description, description about the same points as the embodiments described above will not be repeated.

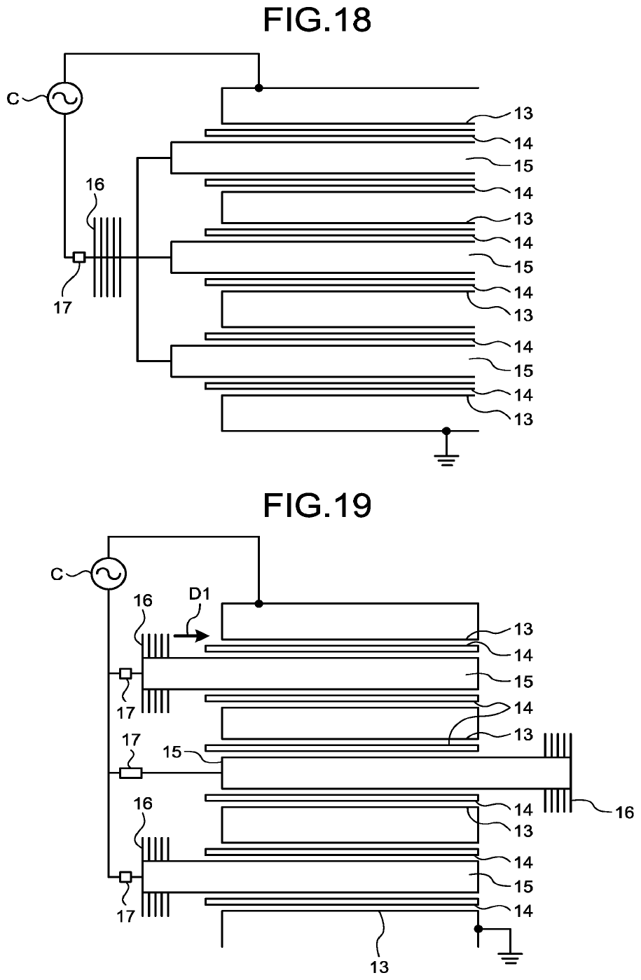

FIG. 18 is a diagram illustrating an example of a configuration of the heat sink of the ozone generator according to a tenth modification. In the present modification, as illustrated in FIG. 18, the heat pipes 15 are connected to one heat sink 16. Thus, in the present modification, the number of the heat sinks 16 disposed in the storage container 12 is smaller than the number of the heat pipes 15 disposed in the storage container 12. For example, the ozone generator according to the present modification includes one heat sink 16 disposed therein corresponding to three heat pipes 15. In this case, the outer diameter of the heat sink 16 may be increased to easily radiate the heat of the heat pipe 15 by the heat sink 16.

Typically, the outer diameter of the heat sink 16 is often caused to be larger than the outer diameter of the heat pipe 15. Thus, if the heat sink 16 is disposed for each heat pipe 15 disposed in the storage container 12, the size of the storage container 12 is increased to prevent the adjacent heat sinks 16 from being in contact with each other. In contrast, according to the present modification, the heat pipes 15 can share the one heat sink 16, so that the size of the ozone generator can be prevented from being increased due to the heat sink 16.

### Eleventh Modification

The present modification is an example in which the heat sinks connected to adjacent heat pipes are alternately connected to the upstream side and the downstream side of the heat pipes in the inflow direction of the material gas. In the following description, description about the same points as the embodiment described above will not be repeated.

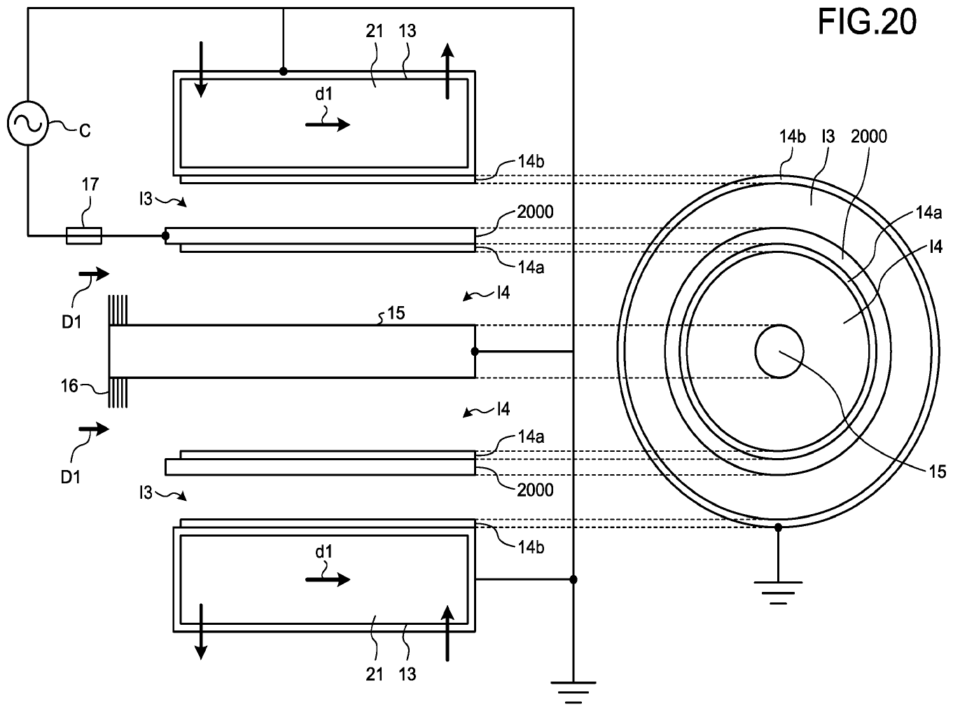

FIG. 19 is a diagram illustrating an example of a configuration of the heat sink of the ozone generator according to an eleventh modification. In the present modification, as illustrated in FIG. 19, the heat sink 16 (hereinafter, referred to as a first heat sink 16) connected to a first heat pipe 15 among the heat pipes 15 disposed in the storage container 12 is disposed on the upstream side of the first heat pipe 15 in the inflow direction Dl of the material gas. The heat sink 16 (hereinafter, referred to as a second heat sink 16) connected to a second heat pipe 15 adjacent to the first heat pipe 15 among the heat pipes 15 disposed in the storage container 12 is disposed on the downstream side of the second heat pipe 15 in the inflow direction Dl of the material gas. In the ozone generator, as provision for a case in which the fuse 17 blows due to an anomaly of the electrode caused by long-term deterioration and the like, an insulation distance between the adjacent heat pipes 15 needs to be maintained. In a case of increasing the size of the heat sink 16 (cooling fin) to enhance a cooling capacity of the heat pipe 15, adjacent cooling fins need to be prevented from colliding with each other. Thus, in the present modification, the heat sinks 16 connected to the adjacent heat pipes 15 are alternately connected to the upstream side and the downstream side of the heat pipe 15 in the inflow direction Dl of the material gas. Due to this, the distance between the adjacent heat pipes 15 can be shortened while maintaining the insulation distance between the adjacent heat pipes 15 in the storage container 12, so that the size of the storage container 12 can be reduced.

### Twelfth Modification

The present modification is an example of using the heat pipe as a grounding electrode. In the following description, description about the same points as the embodiments described above will not be repeated.

FIG. 20 is a diagram for explaining an example of processing of generating ozone performed by the ozone generator according to a twelfth modification. As illustrated in FIG. 20, the ozone generator according to the present modification includes a high-voltage electrode 2000 that is disposed between the inner peripheral surface of the metal electrode 13 and the heat pipe 15 as a cylindrical electrode coaxial with the metal electrode 13. By applying a dielectric to the inner peripheral surface of the high-voltage electrode 2000, a dielectric electrode 14a is brought into intimate contact with the inner peripheral surface. A gap I3 (hereinafter, referred to as a third discharge gap I3) into which the material gas is caused to flow is disposed between the dielectric electrode 14a and the high-voltage electrode 2000.

In the present modification, by applying a dielectric to the inner peripheral surface of the metal electrode 13, a dielectric electrode 14b is brought into intimate contact with the inner peripheral surface of the metal electrode 13. In the present modification, the heat pipe 15 is used as a grounding electrode that is grounded. A gap I4 (hereinafter, referred to as a discharge gap I4) into which the material gas is caused to flow is disposed between the dielectric electrode 14b and the heat pipe 15.

In the ozone generator according to the present modification, voltage is applied to the high-voltage electrode 200 to cause dielectric barrier discharge in the material gas within the third discharge gap I3 and the fourth discharge gap I4, and ozone is generated by the dielectric barrier discharge. With the ozone generator according to the present modification, the heat pipe 15 has the same potential as that of the storage container 12, so that the heat sink 16 can be disposed on the outside of the storage container 12. By water-cooling the heat sink 16 disposed on the outside of the storage container 12, efficiency in cooling the gas in the third discharge gap I3 and the fourth discharge gap I4 by the heat pipe 15 can be further enhanced, and efficiency in generating ozone in the third discharge gap I3 and the fourth discharge gap I4 can be further enhanced.

As described above, according to the first to the fifth embodiments and the first to the twelfth modifications, the material gas in the first discharge gap I1 and the second discharge gap I2 is cooled by both of the heat pipe 15 and the cooling water supplied to the outer peripheral surface of the metal electrode 13, and a temperature rise of the gas in the first discharge gap I1 and the second discharge gap I2 can be suppressed, so that efficiency in generating ozone in the first discharge gap I1 and the second discharge gap I2 can be enhanced.

In the ozone generator according to the embodiments and the modifications described above, the heat sink 16 is preferably at an upper position than the first discharge gap I1 and the second discharge gap I2 are. Due to this, the heat generated in the heat pipe 15 is enabled to easily move to the heat sink 16, and heat radiation efficiency of the heat pipe 15 can be enhanced.

In the embodiments and the modifications described above, the heat pipe 15 is used as the high-voltage electrode, and the metal electrode 13 is used as the grounding electrode. Alternatively, the metal electrode 13 may be used as the high-voltage electrode, and the heat pipe 15 may be used as the grounding electrode. For example, in a case of using the metal electrode 13 as the high-voltage electrode and using the heat pipe 15 as the grounding electrode in the configuration of the ozone generator illustrated in FIG. 2, the dielectric electrode 14 is in intimate contact with the outer peripheral surface of the metal electrode 13. Due to this, the dielectric electrode 14 is brought into intimate contact with both two surfaces of the metal electrode 13 opposed to the two heat pipes 15 adjacent to the metal electrode 13.

In the ozone generator according to the first to the fourth embodiments and the first to the eleventh modifications, the storage container 12 is installed in a state in which the heat pipe 15 extends in parallel with a horizontal direction. Alternatively, the storage container 12 may be installed in a state in which the extending direction of the heat pipe 15 is inclined with respect to the horizontal direction, or in a state in which the extending direction of the heat pipe 15 orthogonally intersects with the horizontal direction.

Some embodiments and modifications of the present invention have been described above. However, these embodiments and modifications are merely examples, and do not intend to limit the scope of the invention. These novel embodiments and modifications can be implemented in various other forms, and can be variously omitted, replaced, and modified without departing from the gist of the present invention. These embodiments and the modifications thereof are encompassed by the scope and the gist of the present invention, and also encompassed by the invention described in CLAIMS and an equivalent thereof.

1: An ozone generator comprising:
a container into which a material gas is caused to flow;
a first metal electrode that is a cylindrical electrode the axial direction of which is a first direction, being disposed in the container, and has an outer peripheral surface to which a cooling medium is supplied;
a cylindrical dielectric electrode that is disposed to be opposed to an inner peripheral surface of the first metal electrode and is coaxial with the first metal electrode;
a heat pipe having electrical conductivity that is disposed to be opposed to an inner peripheral surface of the dielectric electrode;
a heat sink that is disposed on the outside as an outer space of a space between the first metal electrode and the heat pipe, and connected to the heat pipe; and
a power supply unit that applies voltage to the heat pipe to cause electric discharge in the material gas in at least one of a first gap and a second gap to generate ozone by the electric discharge, the first gap being a gap into which the material gas is caused to flow between the first metal electrode and the dielectric electrode, the second gap being a gap into which the material gas is caused to flow between the dielectric electrode and the heat pipe.

2: The ozone generator according to claim 1 wherein
electric discharge is caused in the material gas in both of the first gap and the second gap, and
the ozone generator further comprises a flow channel for the material gas that passes through the first gap after passing through the second gap.

3: The ozone generator according to claim 1, wherein a plurality of the heat pipes are disposed in parallel in the first direction to be opposed to an inner peripheral surface of the one dielectric electrode.

4: The ozone generator according to claim 1, wherein the heat sink is disposed in the container, and is positioned on an upstream side of the first gap in an inflow direction of the material gas.

5: The ozone generator according to claim 4, further comprising:
a stirring unit that stirs the material gas in the container in the vicinity of an inflow port for the material gas in the container.

6: The ozone generator according to claim 1, wherein the heat pipe includes a spiral-shaped groove extending in the first direction on an outer peripheral surface of itself.

7: The ozone generator according to claim 4, wherein a diameter of an inflow port for the material gas into the container is smaller than a diameter of an ejection port for ejecting ozone from the container.

8: The ozone generator according to claim 1, wherein a cylindrical second metal electrode coaxial with the dielectric electrode is disposed, in place of the heat pipe, to be opposed to inner peripheral surfaces of some of a plurality of the dielectric electrodes in the container, and a flow speed of the material gas flowing into the first gap and the second gap is higher than a flow speed of the material gas flowing into a third gap into which the material gas is caused to flow between the second metal electrode and the dielectric electrode or the first metal electrode.

9: The ozone generator according to claim 1, wherein
the container is a cylindrical container the axial direction of which is the first direction, and
the inflow port for the material gas into the container is disposed so that the material gas swirls in a circumferential direction along an inner peripheral surface of the container.

10: The ozone generator according to claim 1, further comprising:
a material gas pipe that is disposed to surround the heat sink, and has an ejection hole for ejecting the material gas toward the heat sink.

11: The ozone generator according to claim 10, further comprising:
a pipe for cooling that is disposed between the heat sink and the material gas pipe to surround the heat sink, the pipe for cooling into which a cooling medium is supplied.

12: The ozone generator according to claim 1, further comprising:
a wall that partitions between a first area and a second area, the first area being an area in which the first metal electrode, the dielectric electrode, and the heat pipe are disposed, the second area being an area in which the heat sink is disposed.

13: The ozone generator according to claim 12, wherein
the wall includes, at one end of itself, a connection hole for connecting the first area to the second area, and
the container includes an inflow port for the material gas into the container at an end of the wall opposite to the end at which the connection hole is disposed.

14: The ozone generator according to claim 13, wherein
the first metal electrode includes, on an inner peripheral surface side thereof, a third metal electrode in which the dielectric electrode and the heat pipe are not disposed, and
the material gas passed through an inner part of the third metal electrode is caused to flow into the second area.

15: The ozone generator according to claim 1, wherein the heat pipes are connected to the one heat sink.

16: The ozone generator according to claim 1, wherein heat sinks connected to the heat pipes adjacent to each other are alternately connected to an upstream side and a downstream side of the heat pipes in an inflow direction of the material gas.

17: The ozone generator according to claim 1, wherein the heat pipe is made of metal or an alloy containing at least one of iron, aluminum, nickel, copper, molybdenum, titanium, chromium, tungsten, silver, gold, and platinum, or the heat pipe is coated by the metal or the alloy.

18: The ozone generator according to claim 1, wherein the heat sink is at an upper position than the first gap is, in the container.
